(19) United States
(12) Patent Application Publication
(10) Pub. No.: US 2026/0120663 A1
(43) Pub. Date: Apr. 30, 2026

(54) DISPLAY DEVICE AND METHOD OF CONTROLLING DISPLAY DEVICE

(71) Applicants: Sharp Kabushiki Kaisha, Sakai City (JP); Sharp Display Technology Corporation, Kameyama City (JP)

(72) Inventors: Jin MIYAZAWA, Sakai City (JP); Daiji KITAGAWA, Sakai City (JP); Yousuke NAKAMURA, Sakai City (JP); Shunsuke ISHII, Sakai City (JP); Kohji SAITOH, Kameyama City (JP)

(21) Appl. No.: 19/369,595

(22) Filed: Oct. 27, 2025

(30) Foreign Application Priority Data
Oct. 30, 2024 (JP) 2024-191094

(51) Int. Cl. G09G 3/36

(52) U.S. Cl. CPC G09G 3/3677; G09G 2310/0286; G09G 2310/08; G09G 2340/0435

(57) ABSTRACT

A display unit, a scan driver configured to drive the display unit, and a controller configured to control the scan driver are provided. The scan driver receives a plurality of clock signals with different phases, and when a first image and a second image with a lower frequency than that of the first image are displayed adjacent to each other, the controller sets a refresh rate switching position according to data of the first image, data of the second image, and phases of the plurality of clock signals.

### BACKGROUND

### 1. Field

The present disclosure relates to a display device.

### 2. Description of the Related Art

Japanese Unexamined Patent Application Publication No. 2011-209714 discloses a scan driver that is used in a display device that performs partial display.

When different refresh rates are used for display, the control of the scan driver becomes complicated.

### SUMMARY

According to an aspect of the disclosure, there is provided a driver circuit including a display unit having a plurality of rows, a scan driver configured to drive the display unit, and a controller configured to control the scan driver. The scan driver receives a plurality of clock signals with different phases, and when a first image and a second image with a lower frequency than that of the first image are displayed adjacent to each other, the controller sets a refresh rate switching position according to data of the first image, data of the second image, and phases of the plurality of clock signals.

### BRIEF DESCRIPTION OF THE DRAWINGS

FIG. 1 is a block diagram illustrating an example structure of a display device according to an embodiment;

FIG. 2 is a block diagram illustrating an example structure of a display device according to the embodiment;

FIG. 3 is a block diagram illustrating an example structure of a scan driver in the display device;

FIG. 4 is a timing chart of a method of controlling the scan driver in the display device;

FIG. 5 is a block diagram illustrating a method of driving the display device;

FIG. 6 is a block diagram illustrating a method of driving the display device;

FIG. 7 is a timing chart illustrating a method of controlling the scan driver in the display device;

FIG. 8 is a timing chart illustrating a method of controlling the scan driver in the display device;

FIG. 9 is a timing chart illustrating a method of controlling the scan driver according to the embodiment and a method of controlling a scan driver according to a comparative example;

FIG. 10 is a flowchart illustrating an operation of a controller;

FIG. 11 is a timing chart illustrating a method of controlling the scan driver in the display device; and

FIG. 12 is a timing chart illustrating a method of controlling the scan driver in the display device.

### DESCRIPTION OF THE EMBODIMENTS

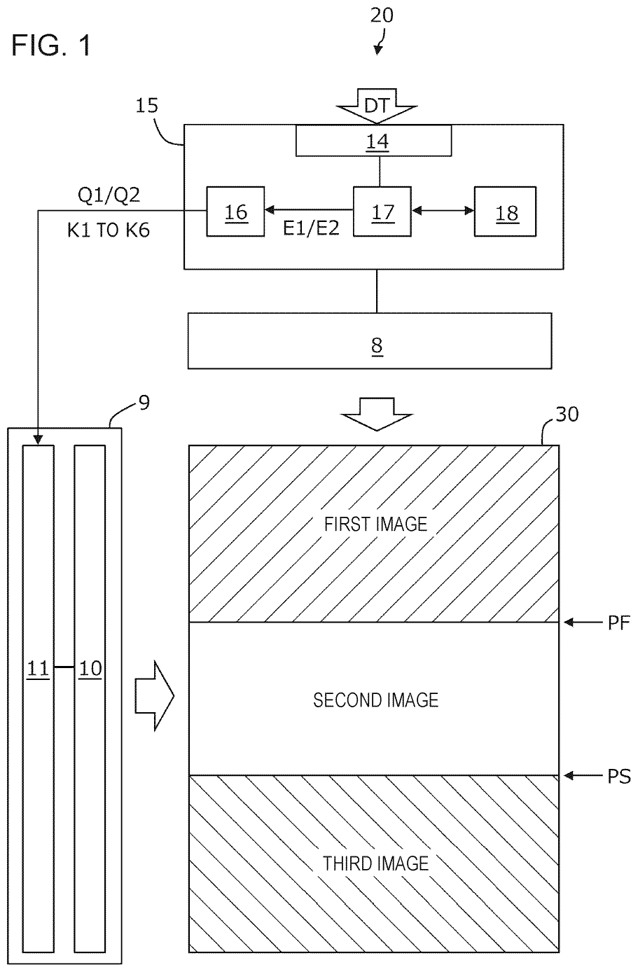

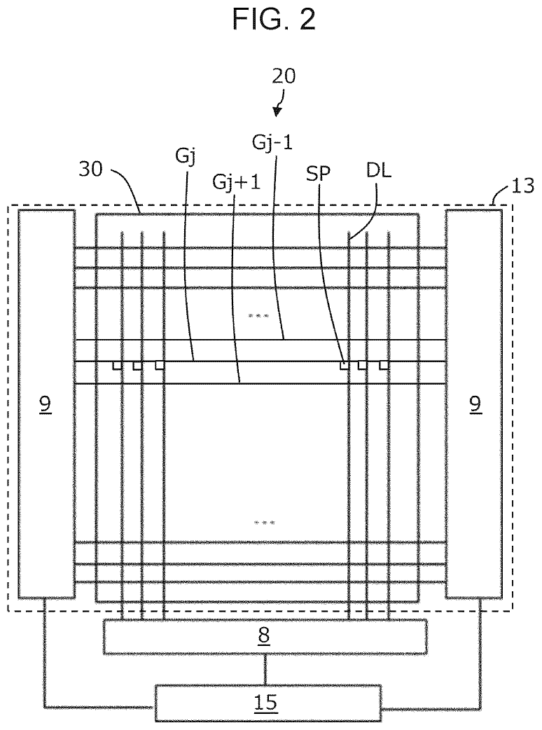

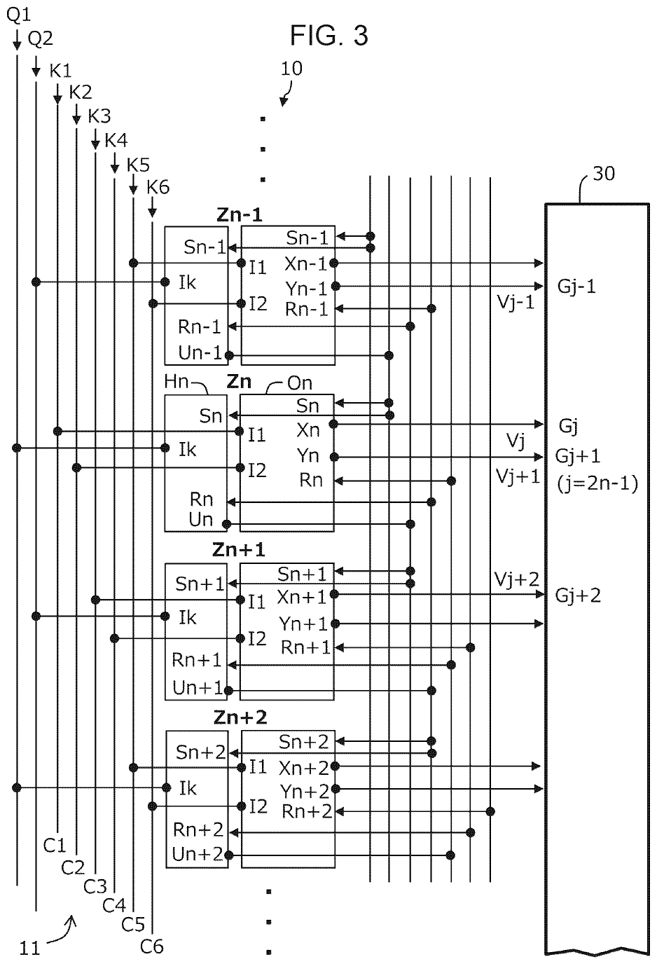

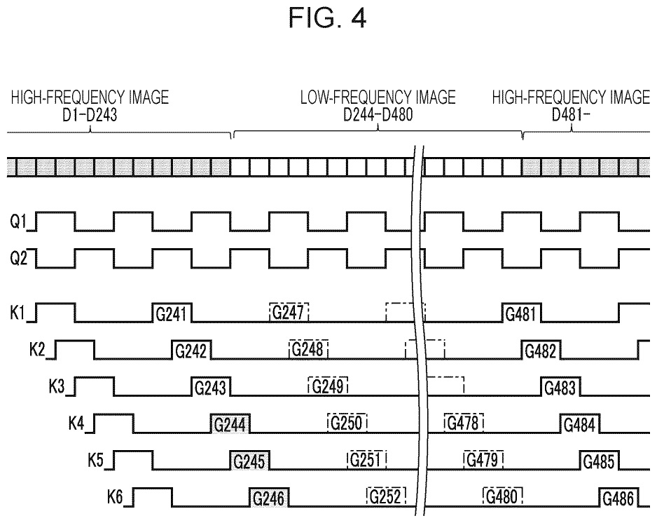

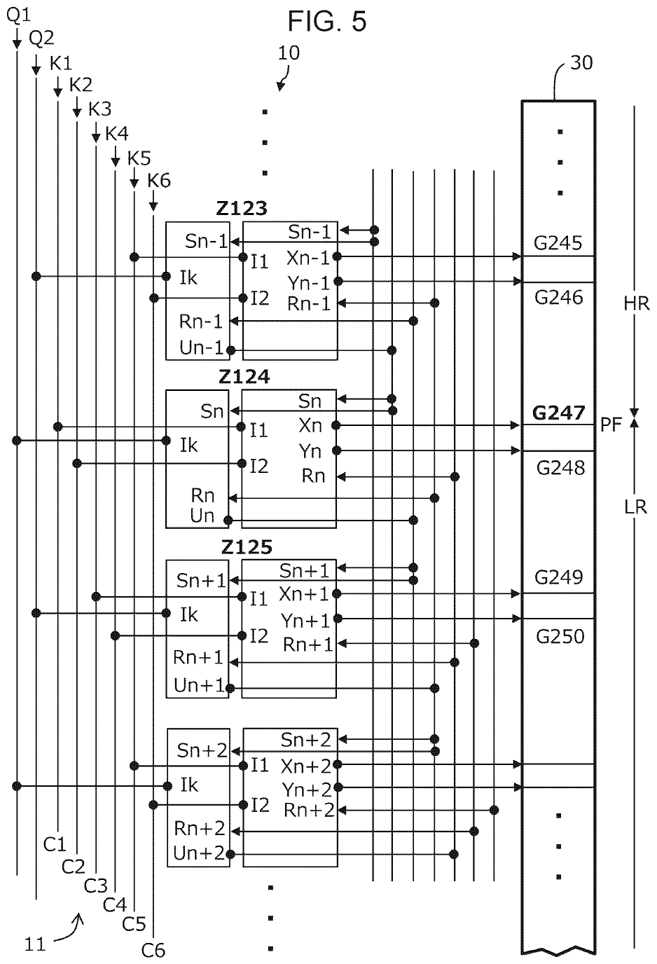

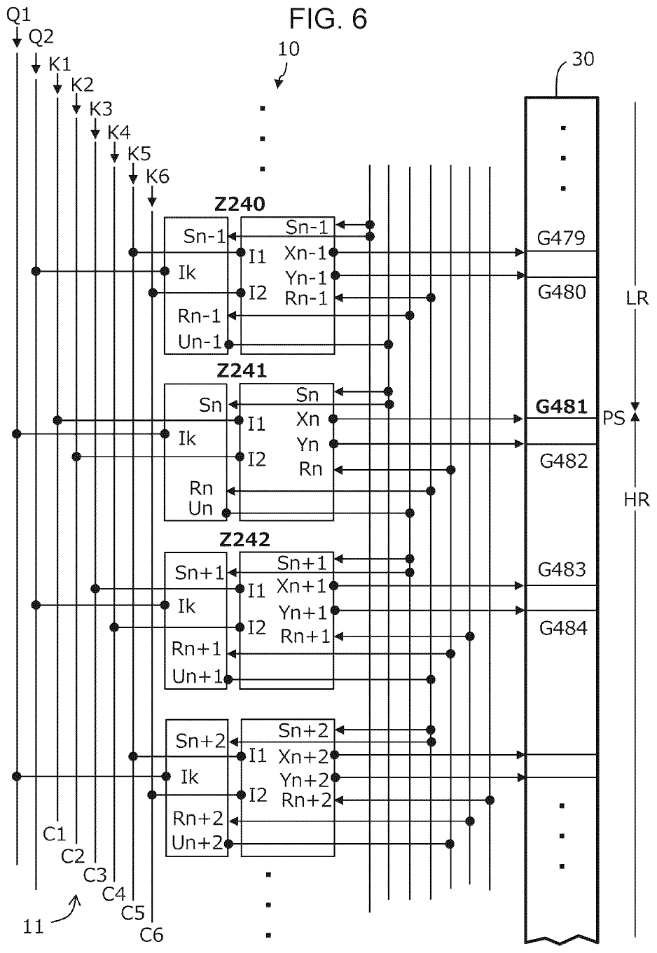

FIG. 1 and FIG. 2 are block diagrams illustrating example structures of a display device according to the embodiment. FIG. 3 is a block diagram illustrating an example structure of a scan driver in the display device. FIG. 4 is a timing chart illustrating a method of controlling the scan driver in the display device. FIG. 5 and FIG. 6 are block diagrams illustrating a method of driving the display device. As illustrated in FIG. 1 to FIG. 6, a display device 20 includes a display unit 30 that has a plurality of rows, a scan driver 9 that drives the display unit 30, and a controller 15 that controls the scan driver 9. The scan driver 9 receives a plurality of clock signals K1 to K6 with different phases. When a first image and a second image with a lower frequency than that of the first image are displayed adjacent to each other, the controller 15 sets a refresh rate (rewrite frequency) switching position PF according to data DT of the first image and the second image and phases of the plurality of clock signals K1 to K6.

Here, pixel rows of the display unit 30 are simply referred to as “rows”. The switching position PF may refer to a switching row. The display unit 30 includes a plurality of scan lines (Gj−1, Gj, Gj+1, etc.) arranged in a first direction (vertical direction), and each row in the display unit 30 includes the scan line. The first and second images are displayed adjacent to each other in the first direction (the column direction perpendicular to the rows), and the second image is updated less frequently than the first image.

With such a structure, by setting a switching position PF based on phases of the plurality of clock signals K1 to K6 in addition to data DT of the first image and the second image, it is possible to control the scan driver 9 more readily.

The controller 15 includes an input unit 14 that receives data DT of the first image and the second image (hereinafter, referred to as data DT), a level shifter IC (level shifter circuit) 16, a timing controller 17, and memory 18. The timing controller 17 generates a control signal that includes reference signals E1 and E2 based on data DT and outputs the signal to the level shifter IC 16.

The level shifter IC 16 generates a plurality of clock signals K1 to K6 and pulse signals Q1 and Q2 based on control signals (including the reference signals E1 and E2) from the timing controller 17. A shift register 10 outputs a scan signal Vj to the scan line Gj in the display unit 30 using the clock signals K1 to K6 and the pulse signals Q1 and Q2 from the level shifter IC 16.

The display device 20 includes a data driver 8 that drives the display unit 30, and the controller 15 controls the data driver 8 and the scan driver 9. A plurality of subpixels SP are arranged in each row (pixel row) of the display unit 30 in the row direction (horizontal direction), and the subpixels SP are connected to data lines DL and the scan line Gj via transistors (not illustrated). The scan driver 9 may be disposed on both sides of the display unit 30. The display unit 30 and the scan driver 9 may be included in a liquid crystal panel 13.

As illustrated in FIG. 3, the scan driver 9 includes the shift register 10 that comprises multiple stages that receive a plurality of clock signals K1 to K6 with different phases, and a clock signal line group 11. The clock signal line group 11 includes first to mth clock signal lines C1 to C6 (m=6) through which the plurality of clock signals K1 to K6 are transmitted respectively.

The first to mth clock signals K1 to K6 (m=6) have the same period, and the phases of the first clock signal K1 and the mth clock signal K6 are shifted by a period of 1/m (=1/6 period). The period of 1/m (=1/6 period) may be equal to one horizontal scanning period.

A unit circuit Zn of an nth stage of the shift register 10 comprises a register circuit Hn that includes a set terminal Sn, a reset terminal Rn, an input terminal Ik for a pulse signal Q1, and a control terminal Un, and an output circuit On that includes clock terminals I1 and I2, a set terminal Sn, a reset terminal Rn, and output terminals Xn and Yn.

In the output circuit On of the unit circuit Zn, the first clock signal K1 is input to the clock terminal I1, and the second clock signal K2 is input to the clock terminal I2. The pulse of the first clock signal K1 is output to the scan line Gj (j=2n−1) via the output terminal Xn, and the pulse of the second clock signal K2 is output to the scan line Gj+1 via the output terminal Yn. In the output circuit of the unit circuit Zn−1, the fifth clock signal K5 is input to the clock terminal I1, and the sixth clock signal K6 is input to the clock terminal I2. The pulse of the sixth clock signal K6 is output to the scan line Gj−1 via the output terminal Yn−1. In the output circuit of the unit circuit Zn+1, the third clock signal K3 is input to the clock terminal I1, and the fourth clock signal K4 is input to the clock terminal I2. The pulse of the third clock signal K3 is output to the scan line Gj+2 via the output terminal Xn+1.

As illustrated in FIGS. 4 to 6, a switching position PF is set to a row (row including the scan line Gj) from which the pulse of the first clock signal K1 (clock of the first clock signal line C1) is output. In other words, the controller 15 sets the same refresh rate as that of the first image (high-frequency image) to a part of the second image (low-frequency image) (increases the refresh rate) such that the switching position PF corresponds to the row (including the scan line Gj) from which the pulse of the first clock signal K1 is output. Specific details are as follows.

When A is a natural number and T is an integer greater than or equal to 0, and the end row of the first image is a row A and the start row of the second image (low-frequency image) is a row (A+1), the controller 15 sets a first refresh rate to the row A to the row (A+T) in the display unit 30, and sets a second refresh rate lower than the first refresh rate to a row (A+T+1), which is a switching position PF. Here, m is the number of phases of the clock signals, 0≤T≤m−1, the first refresh rate is, for example, 60 to 240 [Hz], and the second refresh rate is, for example, 1 to 48 [Hz].

In FIG. 4 and FIG. 5, since m=6 and A=243, by setting the number of adjustment rows T=3, the switching position PF is set to a row that includes the scan line G247 (=243+3+1) from which the pulse of the first clock signal K1 is output. In other words, by increasing the refresh rate for the three rows including the scan lines G244 to G246, which are a part of the low-frequency image (second image), to the same refresh rate as that of the high-frequency image (first image), the refresh rate switching position PF is set to the row 247 (including the scan line G247) from which the pulse of the first clock signal K1 is output.

When B is a natural number greater than A and F is an integer greater than or equal to 0, and the end row of the second image is a row B, the controller 15 sets the second refresh rate to a row (A+T+1) to a row (B−F) in the display unit 30. Here, the number of phases of the clock signals is m, and 0≤F≤m−1.

In FIG. 4 and FIG. 5, since m=6, A=243, and B=480, by setting T=3 and F=0, the second refresh rate is set to the rows 247 (including the scan line G247) to the row 480 (including the scan line G480) in the display unit 30.

In FIG. 4 and FIG. 5, in the display unit 30, the row 1 to the row 246 (including G246) are a high refresh rate region HR, and the row 247 (including G247) to the row 480 (including G480) are a low refresh rate region LR. In such a case, each of the end row (including the scan line G246) of the high refresh rate region HR and the end row (including the scan line G480) of the low refresh rate region LR corresponds to the row from which the pulse of the sixth clock signal K6 is output (row corresponding to a multiple of 6, which is m that is the number of phases of the clock signals).

As illustrated in FIG. 1 to FIG. 6, the controller 15 displays, adjacent to the second image, a third image that has a higher frequency than that of the second image, and when the start row of the third image is a row (B+1), the controller 15 sets a third refresh rate that is different from the second refresh rate to a row (B+1-F) in the display unit 30.

In FIG. 4 and FIG. 6, since m=6 and B=480, by setting the number of adjustment rows F=0, the third refresh rate is set to the row 481 (including the scan line G481) in the display unit 30. In other words, by setting F=0, the refresh rate switching position PS is set to a row that includes the scan line G481 (=480+1−0) from which the pulse of the first clock signal K1 is output. The third refresh rate is, for example, 60 to 240 [Hz].

In FIG. 4 to FIG. 6, in the display unit 30, the row 0 to the row 246 (including the scan line G246) are the high refresh rate region HR, the row 247 (including the scan line G247) to the row 480 (including the scan line G480) are the low refresh rate region LR, and the row 481 (including the scan line G481) and after are the high refresh rate region HR. In such a case, each of the start row (the row 247, which is the switching position PF) in the low refresh rate region LR and the start row (the row 481, which is the switching position PS) in the high refresh rate region HR corresponds to the row that includes the scan line from which the pulse of the first clock signal K1 is output (the row corresponding to the number obtained by adding 1 to the multiple of 6, which is m that is the number of phases of the clock signals).

In the display device 20, in the pulse patterns of the first to mth clock signals during a period in which the second image is not updated, a part that corresponds to a row (A+T+1) to a row (B−F) in the display unit 30 is set to be blank (a flat state with no pulses). Specifically, in the pulse patterns of the six-phase clock signals K1 to K6 illustrated in FIG. 4, the part that corresponds to the row 247 (including the scan line G247) to the row 480 (including the scan line G480) is set to be blank.

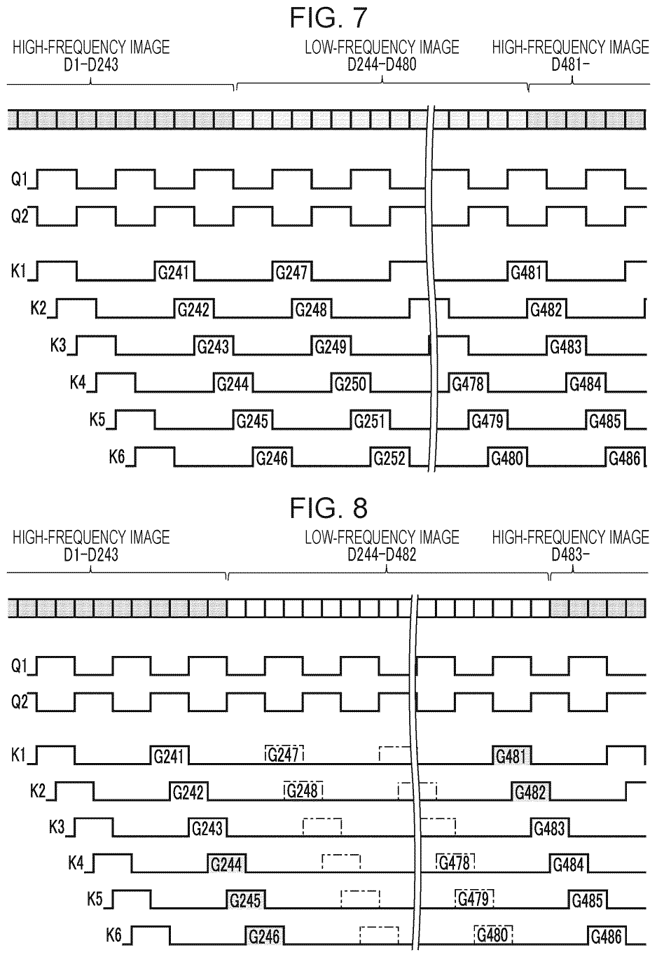

FIG. 7 is a timing chart illustrating a method of controlling the scan driver in the display device. With reference to FIG. 4, the pulse patterns (the part corresponding to the row 247 to the row 480 is blank with no pulses) during the period (frame) in which the second image (low-frequency image) is not updated have been described. In contrast, in a period (frame) in which the second image is updated, pulses are formed also in the part that corresponds to the row 247 to the row 480, as illustrated in FIG. 7. For example, when the first image is 120 [Hz] and the second image is 24 [Hz], the second image is updated once while the first image is updated five times.

FIG. 8 is a timing chart illustrating a method of controlling the scan driver in the display device. In FIG. 8, since m=6 (the number of phases of the clock signals) and B (the end row of the second image)=482, by setting the number of adjustment rows F=2, the third refresh rate is set to the row 481, which is the row corresponding to the row (B+1-F) in the display unit 30. Here, by setting F=2, the refresh rate switching position PS is set to the row that includes the scan line G481 (=480+1−0) from which the pulse of the first clock signal K1 is output. In other words, by increasing the refresh rate for the two rows including the scan lines G481 to G482, which are a part of the low-frequency image (second image), to the same refresh rate as that of the high-frequency image (first image), the refresh rate switching position PS is set to the row 481 (including the scan line G481) from which the pulse of the first clock signal K1 is output. The third refresh rate is, for example, 60 to 240 [Hz]. The first and third refresh rates may be the same.

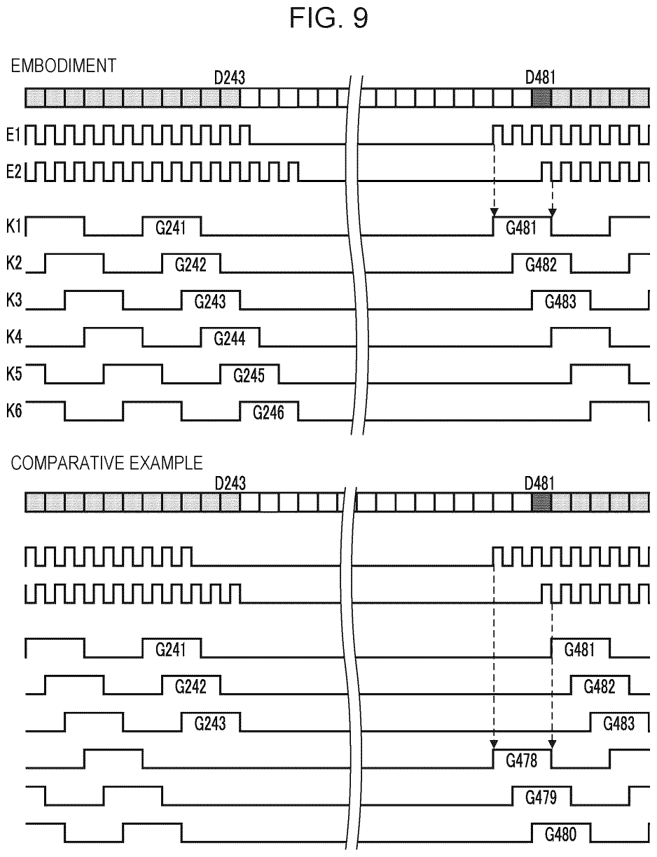

FIG. 9 is a timing chart illustrating a method of controlling the scan driver according to the embodiment and a method of controlling a scan driver according to a comparative example. As illustrated in FIG. 9, the level shifter IC 16 in the display device 20 generates, by using the plurality of reference signals E1 and E2 provided from the timing controller 17, clock signals K1 to K6 that have the number of phases higher than that of the plurality of reference signals E1 and E2.

The frequency of each of the reference signals E1 and E2 is twice or more (for example, six times) of the frequency of each of the clock signals K1 to K6, and the clock signals K1 to K6 rise sequentially as the reference signal E1 rises sequentially, and the clock signals K1 to K6 fall sequentially as the reference signal E2, which is in the reverse phase with the reference signal E1, falls sequentially, thereby forming the pulse pattern of the clock signals K1 to K6.

In this embodiment, the pulse is stopped by the clock signal K6, and the pulse formation is resumed from the clock signal K1, and start row data D481 of the third image is correctly written to the row 481 (including the scan line G481). In contrast, in the comparative example, the pulse is stopped by the clock signal K3, and the pulse formation is resumed from the clock signal K4, and the start row data D481 of the third image is written to the row 478. As a result, a display shift of three lines occurs. To solve the display shift, it is necessary to adjust the output timing of the start row data according to the pulse stop position, and thus the control of the scan driver is difficult.

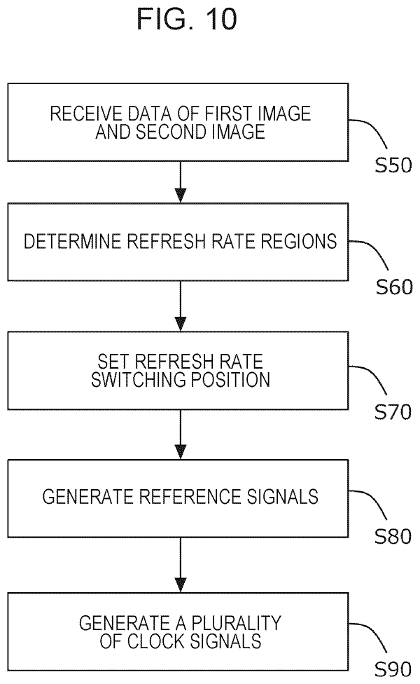

FIG. 10 is a flowchart illustrating an operation of the controller. As illustrated in FIG. 10, the controller 15 receives data of the first image and the second image (step S50), determines refresh rate regions (step S60), sets a refresh rate switching position (step S70), generates reference signals (step S80), and generates a plurality of clock signals (step S90).

The controller 15 may receive externally provided positional information (start row position and end row position) of the first and second images. For example, positional information of the first and second images may be included in externally input data DT, and the refresh rate region determination (step S60) may be performed based on the positional information.

The controller 15 may determine positional information of the first and second images (start row position and end row position) based on time variations of input data DT. For example, time variations may be determined by using data checksum for each unit area (for example, row) that includes a plurality of frames, and refresh rate regions may be determined (step S60) based on the result of the determination.

FIG. 11 is a timing chart illustrating a method of controlling the scan driver in the display device. In FIG. 11, the number of phases of the clock signal is 8, and a plurality of clock signals K1 to K8 are used.

When A is a natural number and T is an integer greater than or equal to 0, and the end row of the first image is a row A and the start row of the second image (low-frequency image) is a row (A+1), the controller 15 sets a first refresh rate to the row A to the row (A+T) in the display unit 30, and sets a second refresh rate lower than the first refresh rate to a row (A+T+1), which is a switching position PF. Here, m is the number of phases of the clock signals, 0≤T≤m−1, the first refresh rate is, for example, 60 to 240 [Hz], and the second refresh rate is, for example, 1 to 48 [Hz].

In FIG. 11, since m=8 and A=236, by setting T=4, the switching position PF is set to a row that includes the scan line G241 (=236+4+1) from which the pulse of the first clock signal K1 is output. In other words, by increasing the refresh rate for the four rows including the scan lines G237 to G240, which are a part of the low-frequency image (second image), to the same refresh rate as that of the high-frequency image (first image), the refresh rate switching position PF is set to the row 241 (including the scan line G241) from which the pulse of the first clock signal K1 is output.

When B is a natural number greater than A and F is an integer greater than or equal to 0, and the end row of the second image is a row B, the controller 15 sets the second refresh rate to a row (A+T+1) to a row (B−F) in the display unit 30. Here, the number of phases of the clock signals is m, and 0≤F≤m−1.

In FIG. 11, since m=8, A=236, and B=408, by setting the number of adjustment rows T=4 and F=0, the second refresh rate is set to the row 241 (including the scan line G241) to the row 408 (including the scan line G408) in the display unit 30.

In FIG. 11, in the display unit 30, the row 0 to the row 240 (including G240) are a high refresh rate region, and the row 241 (including G241) to the row 408 (including G408) are a low refresh rate region. In such a case, each of the end row (including the scan line G240) of the high refresh rate region and the end row (including the scan line G408) of the low refresh rate region corresponds to the row from which the pulse of the eighth clock signal K8 is output (row corresponding to a multiple of 8, which is m that is the number of phases of the clock signals).

As illustrated in FIG. 1 and FIG. 11, the controller 15 displays, adjacent to the second image, the third image that has a higher frequency than that of the second image, and when the start row of the third image is a row (B+1), the controller 15 sets the third refresh rate that is different from the second refresh rate to a row (B+1-F) in the display unit 30.

In FIG. 11, since m=8 and B=408, by setting the number of adjustment rows F=0, the third refresh rate is set to the row 409 (including the scan line G409) in the display unit 30. In other words, by setting F=0, the refresh rate switching position PS is set to the row that includes the scan line G409 (=408+1−0) from which the pulse of the first clock signal K1 is output. The third refresh rate is, for example, 60 to 240 [Hz].

In FIG. 11, in the display unit 30, the row 0 to the row 240 (including the scan line G240) are the high refresh rate region, the row 241 (including the scan line G241) to the row 408 (including the scan line G408) are the low refresh rate region, and the row 409 (including the scan line G409) and after are the high refresh rate region. In such a case, each of the start row (the row 241, which is the switching position PF) in the low refresh rate region and the start row (the row 409, which is the switching position PS) in the high refresh rate region corresponds to the row that includes the scan line from which the pulse of the first clock signal K1 is output (the row corresponding to the number obtained by adding 1 to the multiple of 8, which is m that is the number of phases of the clock signals).

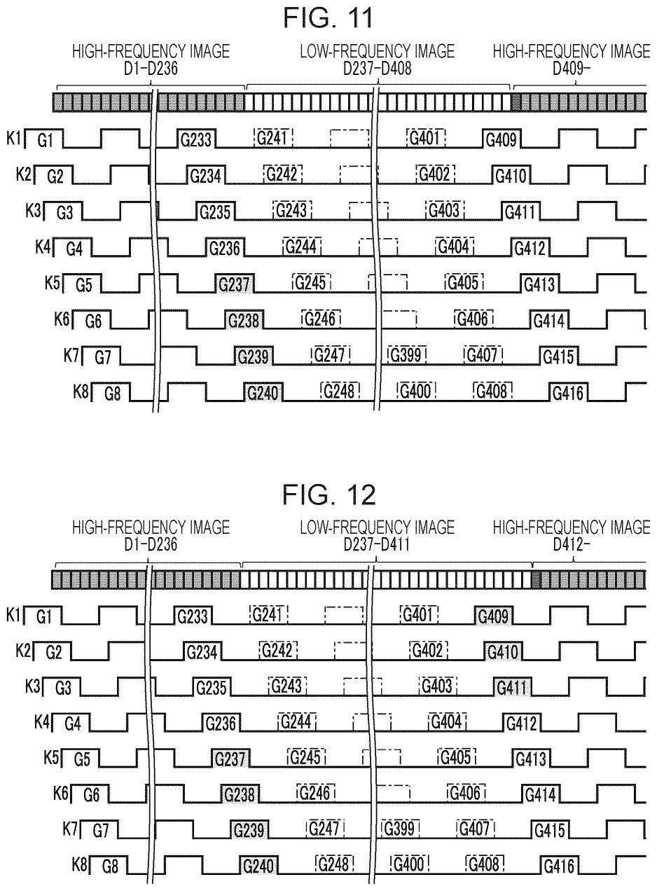

FIG. 12 is a timing chart illustrating a method of controlling the scan driver in the display device. In FIG. 12, since m=8 and B (the end row of the second image)=411, by setting the number of adjustment rows F=3, the third refresh rate is set to the row 409, which is the row corresponding to the row (B+1−F) in the display unit 30. Here, by setting F=3, the refresh rate switching position PS is set to the row that includes the scan line G409 (=411+1−3) from which the pulse of the first clock signal K1 is output. In other words, by increasing the refresh rate for the three rows including the scan lines G409 to G411, which are a part of the low-frequency image (second image), to the same refresh rate as that of the high-frequency image (first image), the refresh rate switching position PS is set to the row 409 (including the scan line G409) from which the pulse of the first clock signal K1 is output. The third refresh rate is, for example, 60 to 240 [Hz]. The first and third refresh rates may be the same.

[Summary] A display device according to a first aspect includes a display unit having a plurality of rows, a scan driver configured to drive the display unit, and a controller configured to control the scan driver. The scan driver receives a plurality of clock signals with different phases, and when a first image and a second image with a lower frequency than that of the first image are displayed adjacent to each other, the controller sets a refresh rate switching position according to data of the first image, data of the second image, and phases of the plurality of clock signals.

A display device according to a second aspect, in the display device according to the first aspect, when m is an integer greater than or equal to 2, the plurality of clock signals may be the first to mth clock signals, and the switching position may be a row from which a pulse of the first clock signal is output.

A display device according a third aspect, in the display device according to the first or second aspect, the controller may set the same refresh rate as that of the first image to a part of the second image such that the switching position corresponds to the row from which the pulse of the first clock signal is output.

A display device according to a fourth aspect, in the display device according to any one of the first to third aspects, when A is a natural number and T is an integer greater than or equal to 0, and an end row of the first image is a row A and a start row of the second image is a row (A+1), the controller may set a first refresh rate to the row A to the row (A+T) in the display unit, and set a second refresh rate that is lower than the first refresh rate to a row (A+T+1) that is the switching position.

A display device according to a fifth aspect, in the display device according to the fourth aspect, when B is a natural number greater than A and F is an integer greater than or equal to 0, and an end row of the second image is a row B, the controller may set the second refresh rate to the row (A+T+1) to a row (B−F) in the display unit.

A display device according to a sixth aspect, in the display device according to the fourth aspect, T may be 0≤T≤m−1.

A display device according to a seventh aspect, in the display device according to the fifth aspect, F may be 0≤F≤m−1.

A display device according to an eighth aspect, in the display device according to the fifth aspect, the pulse of the first clock signal may be output to each of the row (A+T+1) and the row (B−F+1).

A display device according to a ninth aspect, in the display device according to the fifth aspect, in the shift register, the pulse of the mth clock signal may be output to each of the row (A+T) and the row (B−F).

A display device according to a tenth aspect, in the display device according to the fifth aspect, the controller may display, adjacent to the second image, a third image that has a higher frequency than that of the second image, and when a start row of the third image is a row (B+1), the controller sets a third refresh rate that is higher than the second refresh rate to a row (B+1−F) in the display unit.

A display device according to an eleventh aspect, in the display device according to the fifth aspect, in the pulse patterns of the first to mth clock signals, a part that corresponds to the row (A+T+1) to the row (B−F) in the display unit may be set to be blank.

A display device according to a twelfth aspect, in the display device according to any one of the second to eleventh aspects, the first to mth clock signals may have the same period and the phases of the first clock signal and the mth clock signal may be shifted by a period of 1/m.

A display device according to a thirteenth aspect, in the display device according to the twelfth aspect, the period of 1/m may be equal to one horizontal scanning period.

A display device according to a fourteenth aspect, in the display device according to any one of the first to thirteenth aspects, the display unit may include a plurality of scan lines arranged in a first direction, and the first and second images may be displayed adjacent to each other in the first direction.

A display device according to a fifteenth aspect, in the display device according to any one of the first to fourteenth aspects, the controller may receive externally provided positional information of the first and second images.

A display device according to a sixteenth aspect, in the display device according to any one of the first to fifteenth aspects, the controller may determine positional information of the first and second images based on time variations of the images.

A display device according to a seventeenth aspect, in the display device according to the sixteenth aspect, the controller may determine the time variations by using data checksum for each unit area.

A display device according to an eighteenth aspect, in the display device according to any one of the first to seventeenth aspects, the controller may include a timing controller and a level shifter circuit (IC).

A display device according to a nineteenth aspect, in the display device according to the eighteenth aspect, the level shifter circuit may generate, by using a plurality of reference signals provided from the timing controller, the plurality of clock signals that have the number of phases higher than that of the plurality of reference signals.

A method of driving a display device according to a twentieth aspect, the display device including a display unit having a plurality of rows, a scan driver configured to drive the display unit, and a controller configured to control the scan driver, in which the scan driver receives a plurality of clock signals with different phases, the method includes, when a first image and a second image with a lower frequency than that of the first image are displayed adjacent to each other, setting a refresh rate switching position according to data of the first image, data of the second image, and phases of the plurality of clock signals.

The present disclosure contains subject matter related to that disclosed in Japanese Priority Patent Application JP 2024-191094 filed in the Japan Patent Office on Oct. 30, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display unit having a plurality of rows;
a scan driver configured to drive the display unit; and
a controller configured to control the scan driver, wherein
the scan driver receives a plurality of clock signals with different phases, and
when a first image and a second image with a lower frequency than that of the first image are displayed adjacent to each other, the controller sets a refresh rate switching position according to data of the first image, data of the second image, and phases of the plurality of clock signals.

2. The display device according to claim 1, wherein
when m is an integer greater than or equal to 2, the plurality of clock signals are the first to mth clock signals, and
the switching position is a row from which a pulse of the first clock signal is output.

3. The display device according to claim 2, wherein the controller sets a same refresh rate as that of the first image to a part of the second image such that the switching position corresponds to the row from which the pulse of the first clock signal is output.

4. The display device according to claim 2, wherein when A is a natural number and T is an integer greater than or equal to 0, and an end row of the first image is a row A and a start row of the second image is a row (A+1), the controller sets a first refresh rate to the row A to the row (A+T) in the display unit, and sets a second refresh rate that is lower than the first refresh rate to a row (A+T+1) that is the switching position.

5. The display device according to claim 4, wherein when B is a natural number greater than A and F is an integer greater than or equal to 0, and an end row of the second image is a row B, the controller sets the second refresh rate to the row (A+T+1) to a row (B−F) in the display unit.

6. The display device according to claim 4, wherein 0≤T≤m−1.

7. The display device according to claim 5, wherein 0≤F≤m−1.

8. The display device according to claim 5, wherein the pulse of the first clock signal is output to each of the row (A+T+1) and the row (B−F+1).

9. The display device according to claim 5, wherein in the shift register, the pulse of the mth clock signal is output to each of the row (A+T) and the row (B−F).

10. The display device according to claim 5, wherein the controller displays, adjacent to the second image, a third image that has a higher frequency than that of the second image, and when a start row of the third image is a row (B+1), the controller sets a third refresh rate that is higher than the second refresh rate to a row (B+1−F) in the display unit.

11. The display device according to claim 5, wherein in the pulse patterns of the first to mth clock signals, a part that corresponds to the row (A+T+1) to the row (B−F) in the display unit is set to be blank.

12. The display device according to claim 2, wherein
the first to mth clock signals have a same period, and
the phases of the first clock signal and the mth clock signal are shifted by a period of 1/m.

13. The display device according to claim 12, wherein the period of 1/m is equal to one horizontal scanning period.

14. The display device according to claim 1, wherein
the display unit includes a plurality of scan lines arranged in a first direction, and
the first and second images are displayed adjacent to each other in the first direction.

15. The display device according to claim 1, wherein the controller receives externally provided positional information of the first and second images.

16. The display device according to claim 1, wherein the controller determines positional information of the first and second images based on time variations of the images.

17. The display device according to claim 16, wherein the controller determines the time variations by using data checksum for each unit area.

18. The display device according to claim 1, wherein the controller includes a timing controller and a level shifter circuit.

19. The display device according to claim 18, wherein the level shifter circuit generates, by using a plurality of reference signals provided from the timing controller, the plurality of clock signals that have the number of phases higher than that of the plurality of reference signals.

20. A method of controlling a display device comprising a display unit having a plurality of rows, a scan driver configured to drive the display unit, and a controller configured to control the scan driver, in which the scan driver receives a plurality of clock signals with different phases, the method comprising:
when a first image and a second image with a lower frequency than that of the first image are displayed adjacent to each other, setting a refresh rate switching position according to data of the first image, data of the second image, and phases of the plurality of clock signals.
